(19) United States
(12) Patent Application Publication
(10) Pub. No.: US 2015/0015586 A1
(43) Pub. Date: Jan. 15, 2015

(54) SYSTEMS AND METHODS FOR RENDERING AND DOWNSAMPLING AN IMAGE

(71) Applicants: Paul MESSMER, Issaquah, WA (US); David TEITLEBAUM, Seattle, WA (US)

(72) Inventors: Paul MESSMER, Issaquah, WA (US); David TEITLEBAUM, Seattle, WA (US)

(73) Assignee: GOOGLE INC., Mountain View, CA (US)

(21) Appl. No.: 13/427,780

(22) Filed: Mar. 22, 2012

(51) Int. Cl. G06T 11/20

(52) U.S. Cl. 345/443

(57) ABSTRACT

Systems and methods for rendering and downsampling an image are provided. In some aspects, a system includes an instructions module configured to receive one or more drawing instructions associated with a first image. The instructions module is further configured to generate line operations based on the one or more drawing instructions by encoding the first image. Each of the line operations corresponds to a scanline of the first image and comprises a run-length encoded version of a corresponding scanline of the first image. The system also includes a playback module configured to render a portion of the first image at a time based on a predetermined number of the line operations. The predetermined number is based on a downsampling factor for downsampling the first image.

### FIELD

The subject technology generally relates to image rendering and, in particular, relates to systems and methods for rendering and downsampling images.

### BACKGROUND

Antialiasing may be employed to reduce or eliminate aliasing of an image (e.g., jagged and/or pixelated edges displayed in the image). Aliasing may occur because real-world objects have continuous, smooth curves and lines, whereas monitors may only display discrete pixels. Since pixels are typically of the same shape, the curves and lines in an image can become jagged. Antialiasing may smooth the jagged lines and curves in the image. However, certain antialiasing techniques may involve rendering images at a much higher resolution than the resolution of the desired images to be displayed. As a result, rendering such high-resolution images can be computationally intensive.

### SUMMARY

According to various aspects of the subject technology, a system for rendering and downsampling an image is provided. The system comprises an instructions module configured to receive one or more drawing instructions associated with a first image. The instructions module is further configured to generate line operations based on the one or more drawing instructions. Each of the line operations corresponds to a scanline of the first image. The system also comprises a playback module configured to render a portion of the first image at a time based on a predetermined number of the line operations. The predetermined number is based on a downsampling factor for downsampling the first image.

According to various aspects of the subject technology, a computer-implemented method for rendering and downsampling an image is provided. The method comprises receiving one or more drawing instructions associated with a first image. The method also comprises generating line operations based on the one or more drawing instructions. Each of the line operations corresponds to a scanline of the first image. The method also comprises rendering a portion of the first image at a time based on a predetermined number of the line operations. The predetermined number is based on a downsampling factor for downsampling the first image.

According to various aspects of the subject technology, a system for rendering and downsampling an image is provided. The system comprises an image processor configured to receive one or more drawing instructions associated with a first image. The image processor is also configured to generate line operations based on the one or more drawing instructions. Each of the line operations corresponds to a scanline of the first image. The image processor is also configured to render a portion of the first image at a time based on a predetermined number of the line operations. The predetermined number is based on a downsampling factor for downsampling the first image.

According to various aspects of the subject technology, a machine-readable medium encoded with executable instructions for rendering and downsampling an image is provided. The instructions comprise code for receiving one or more drawing instructions associated with a first image and code for generating line operations based on the one or more drawing instructions. Each of the line operations corresponds to a scanline of the first image. Each of the line operations comprises a run-length encoded version of a corresponding scanline of the first image. The instructions also comprise code for rendering a portion of the first image at a time based on a predetermined number of the line operations. The predetermined number is based on a downsampling factor for downsampling the first image. The instructions also comprise code for downsampling the portion of the first image according to the downsampling factor to generate a portion of a second image.

According to various aspects of the subject technology, a system for rendering and downsampling an image is provided. The system comprises an instructions module configured to receive one or more drawing instructions associated with a first image. The instructions module is further configured to generate line operations based on the one or more drawing instructions by encoding the first image. Each of the line operations corresponds to a scanline of the first image. Each of the line operations comprises a run-length encoded version of a corresponding scanline of the first image. The system also comprises a playback module configured to render a portion of the first image at a time based on a predetermined number of the line operations. The predetermined number is based on a downsampling factor for downsampling the first image.

According to various aspects of the subject technology, a computer-implemented method for rendering and downsampling an image is provided. The method comprises receiving one or more drawing instructions associated with a first image. The method also comprises generating line operations based on the one or more drawing instructions by encoding the first image. Each of the line operations corresponds to a scanline of the first image. Each of the line operations comprises a run-length encoded version of a corresponding scanline of the first image. The method also comprises rendering a portion of the first image at a time based on a predetermined number of the line operations. The predetermined number is based on a downsampling factor for downsampling the first image.

According to various aspects of the subject technology, a system for rendering and downsampling an image is provided. The system comprises an image processor configured to receive one or more drawing instructions associated with a first image. The image processor is also configured to generate line operations based on the one or more drawing instructions by encoding the first image. Each of the line operations corresponds to a scanline of the first image. Each of the line operations comprises a run-length encoded version of a corresponding scanline of the first image. The image processor is also configured to render a portion of the first image at a time based on a predetermined number of the line operations. The predetermined number is based on a downsampling factor for downsampling the first image.

According to various aspects of the subject technology, a machine-readable medium encoded with executable instructions for rendering and downsampling an image is provided. The instructions comprise code for receiving one or more drawing instructions associated with a first image and code for generating line operations based on the one or more drawing instructions by encoding the first image. Each of the line operations corresponds to a scanline of the first image. Each of the line operations comprises a run-length encoded version of a corresponding scanline of the first image. The instructions also comprise code for rendering a portion of the first image at a time based on a predetermined number of the line operations. The predetermined number is based on a downsampling factor for downsampling the first image. The instructions also comprise code for downsampling the portion of the first image according to the downsampling factor to generate a portion of a second image.

Additional features and advantages of the subject technology will be set forth in the description below, and in part will be apparent from the description, or may be learned by practice of the subject technology. The advantages of the subject technology will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the subject technology and are incorporated in and constitute a part of this specification, illustrate aspects of the subject technology and together with the description serve to explain the principles of the subject technology.

FIG. 1 illustrates an example of a system for rendering and downsampling an image, in accordance with various aspects of the subject technology.

FIG. 2 illustrates an example of a method for rendering and downsampling an image, in accordance with various aspects of the subject technology.

FIG. 3 illustrates an example of a set of line operations, in accordance with various aspects of the subject technology.

FIG. 4 illustrates an example of a first image, in accordance with various aspects of the subject technology.

FIG. 5 illustrates an example of a second image, in accordance with various aspects of the subject technology.

FIG. 6 is a block diagram illustrating components of a controller, in accordance with various aspects of the subject technology.

### DETAILED DESCRIPTION

In the following detailed description, numerous specific details are set forth to provide a full understanding of the subject technology. It will be apparent, however, to one ordinarily skilled in the art that the subject technology may be practiced without some of these specific details. In other instances, well-known structures and techniques have not been shown in detail so as not to obscure the subject technology.

According to various aspects of the subject technology, an approach is provided for handling images such that central processing units (CPUs) or other processing modules may render the images in a quick and efficient manner. This approach may be particularly useful for rasterizing images for a map. For example, these images may display portions of the map with one or more blocks of solid colors that signify routes on the map. According to certain aspects, supersampling may be employed as an antialiasing technique to reduce or eliminate aliasing of the images. An image may be supersampled by taking samples at several instances inside one or more pixels of the image, and calculating average color values for each of the corresponding pixels. The samples may be taken by rendering the image at a much higher resolution than a desired resolution of the image to be displayed, and then downsampling (e.g., shrinking) the higher-resolution image to the desired resolution, using extra pixels for calculating the downsampled image. Supersampling, for example, may result in smoother transitions from one line of pixels to another along edges of objects displayed in an image.

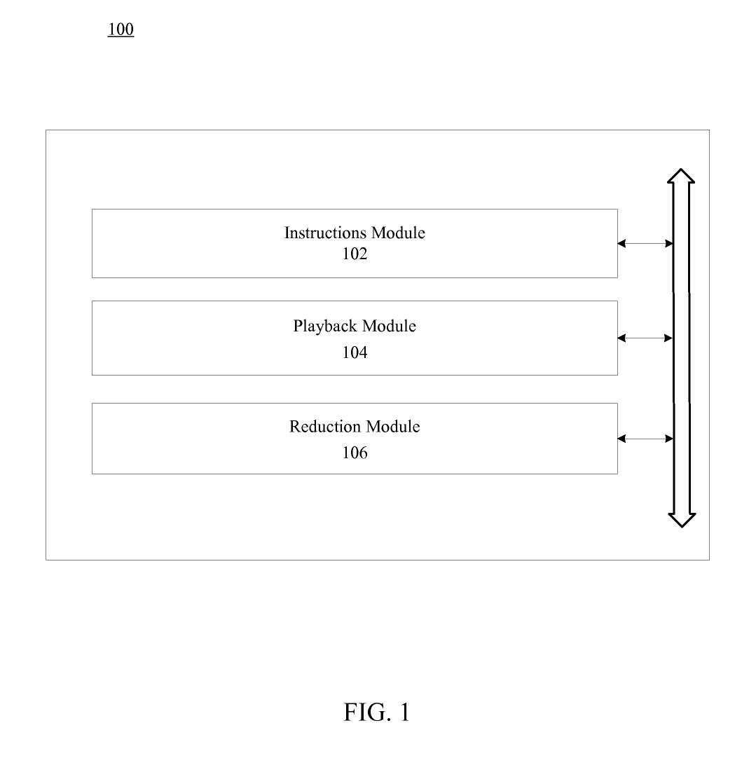

FIG. 1 illustrates an example of system 100 for rendering and downsampling an image, in accordance with various aspects of the subject technology. System 100 comprises instructions module 102, playback module 104, and reduction module 106. These modules may be in communication with one another. In some aspects, the modules may be implemented in software (e.g., subroutines and code). In some aspects, some or all of the modules may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both. Additional features and functions of these modules according to various aspects of the subject technology are further described in the present disclosure.

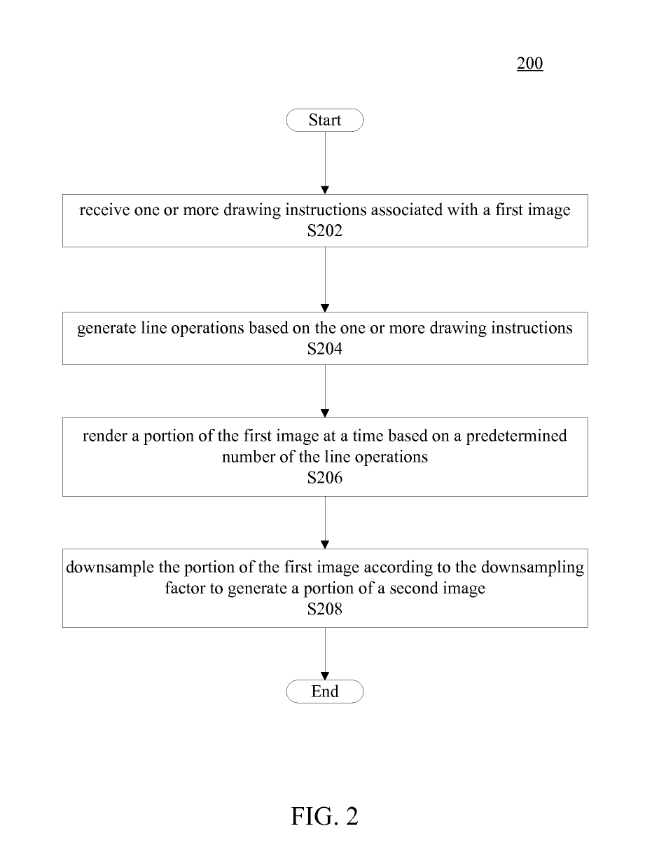

FIG. 2 illustrates an example of method 200 for rendering and downsampling an image, in accordance with various aspects of the subject technology. System 100 may be used to implement method 200 to apply antialiasing to a particular image. For example, system 100 may implement method 200 to render a first image and downsample the first image into a second image. The first image, for example, may be a supersampled image. The second image may be a downsampled version of the supersampled image.

According to step S202, instructions module 102 may receive one or more drawing instructions associated with the first image. The one or more drawing instructions, for example, may provide information as to the desired image to be drawn (e.g., the first image). As discussed above, the first image may comprise a particular portion of a map that, when rendered and treated for aliasing, may be provided over a network from a server to an electronic device running a mapping application. The electronic device, for example, may comprise a desktop computer, a laptop computer, a tablet, a mobile phone, or any suitable computing device for running the mapping application. The electronic device may use the mapping application to view the rendered and downsampled image on a display of the electronic device.

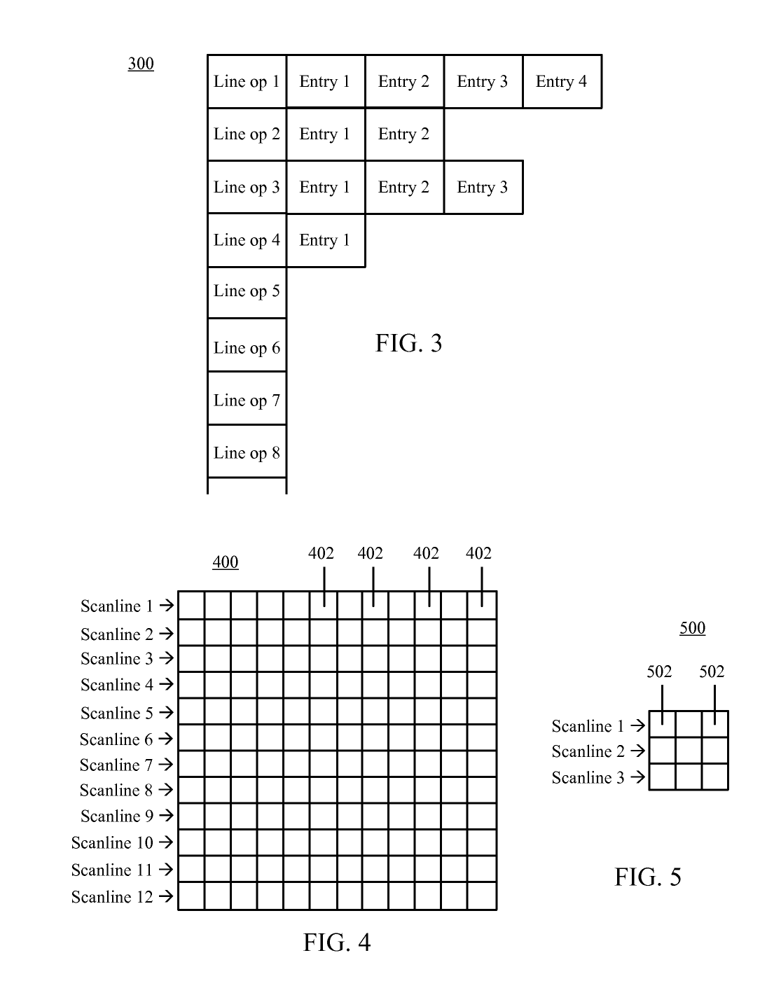

According to step S204, instructions module 102 may generate line operations based on the received one or more drawing instructions. Each of the line operations may correspond to a scanline of the first image. For example, each of the line operations may provide information for rendering a corresponding scanline of the first image, and may be referred to as a “line op.” FIG. 3 illustrates an example of set 300 of line operations, in accordance with various aspects of the subject technology. As shown in FIG. 3, set 300 comprises at least eight line operations (e.g., line op 1 to line op 8). Each of these line operations may correspond to a scanline of the first image. FIG. 4 illustrates an example of first image 400, in accordance with various aspects of the subject technology. As shown, first image 400 comprises 12 scanlines (e.g., shown as scanline 1 to scanline 12), with each of these scanlines comprising a plurality of pixels 402. However, first image 400 may be any suitable size, with greater or fewer scanlines and/or pixels. For example, first image 400 may have a resolution of 1024 by 1024 pixels, and therefore may comprise 1024 scanlines, with each of these scanlines comprising 1024 pixels. Each of the line operations of set 300 may correspond to a scanline of first image 400. For example, line op 1 may provide information for rendering scanline 1 of first image 400, line op 2 may provide information for rendering scanline 2 of first image 400, line op 3 may provide information for rendering scanline 3 of first image 400, and so on.

According to certain aspects, instructions module 102 may generate set 300 of line operations by encoding first image 400 (as determined from the one or more drawing instructions in step S202). For example, each of the line operations may be a run-length encoded version of a corresponding scanline of first image 400. According to certain aspects, run-length encoding may involve data compression, wherein runs of data (e.g., sequences in which the same data value occurs in many consecutive data elements such as pixels) can be stored as a single data value and count. Run-length encoding may be particularly useful for data that contains many such runs, such as simple graphic images, icons, line drawings, blocks of solid colors on a map, and other suitable types of images.

By using run-length encoding, set 300 may be stored in less space than storing first image 400 directly. For example, each of the line operations may comprise one or more entries (e.g., each entry may correspond to a particular run of data). As shown in FIG. 3, line op 1 comprises four entries (e.g., entry 1 to entry 4), line op 2 comprises two entries (e.g., entry 1 and entry 2), line op 3 comprises three entries (e.g., entry 1 to entry 3), and line op 4 comprises one entry (e.g., entry 1). In some aspects, each of the entries may comprise a rendering operation associated with at least a portion of a corresponding scanline. In some aspects, each rendering operation may comprise at least one of a color descriptor or a location descriptor associated with the color descriptor for rendering at least a portion of a corresponding scanline of first image 400. For example, a particular color descriptor may specify the color green, and a location descriptor (associated with the green color descriptor) may identify a starting and ending pixel on a scanline of first image 400 to be colored green. In some aspects, each rendering operation may comprise at least one of a color descriptor or at least a portion of first image 400 to be drawn. This configuration may be useful for rendering text, where bits of the text can be encoded as part of the rendering operation.

According to certain aspects, each of the one or more entries may have a particular size, such as less than or equal to eight bytes. Each pixel 402 of first image 400 may also have a particular size, such as four bytes. Thus, if enough entries are stored (depending on the contents of first image 400), then set 300 may potentially be stored in more space than storing first image 400 directly, thereby obviating the advantages of using run-length encoding. In order to address this problem, instructions module 102 may compare a size of each of the line operations of set 300 to a size of a corresponding scanline of first image 400, and determine whether to generate the line operations based on this comparison. For example, if the size of the line operations is greater than or equal to the size of the corresponding scanline of first image 400, instructions module 102 may determine not to generate the line operations, but rather store first image 400 directly. Otherwise, instructions module 102 may determine to generate the line operations.

According to certain aspects, instructions module 102 may also compare a size of set 300 (as opposed to a size each line operation individually) to a size of first image 400 (as opposed to a size of each scanline of first image 400 individually). Instructions module 102 may determine whether to generate the line operations based on this comparison. For example, if the size of set 300 is greater than or equal to the size of first image 400, instructions module 102 may determine not to generate the line operations, but rather store first image 400 directly. Otherwise, instructions module 102 may determine to generate the line operations.

Once one or more line operations of set 300 is generated, playback module 104 may render a portion of first image 400 at a time based on a predetermined number of the line operations (e.g., execute the predetermined number of the line operations at a time), according to step S206. For example, playback module 104 may render scanline 1 through scanline 4 of first image 400 based on line op 1 through line op 4 of set 300. In some aspects, playback module 104 may render the portion of first image 400 by rasterizing the portion of first image 400. Because only a portion of first image 400 may be rendered at a time, the amount of memory (e.g., cache) needed on a CPU that is performing the rendering may be reduced. This memory, for example, may store at least one of the corresponding line operations being performed, the corresponding scanlines, or other suitable information for performing the rendering of the portion of first image 400. In this regard, by storing this rendering information associated with a portion of first image 400 in the memory (rather than storing rendering information associated with the entire first image 400 at once in the memory), the rendering information associated with the portion of first image 400 is much more likely to fit completely within the CPU's memory when performing the rendering and downsampling. As a result, the time for rendering the portion of first image 400 may be reduced because the CPU can access the memory on the CPU more quickly than it can access other memory that is not on the CPU (e.g., non-cache memory). Furthermore, rendering a portion of first image 400 at a time allows alpha blending (e.g., generating one or more new colors using a blend function with existing colors) to be implemented without having to necessarily store the one or more new colors with set 300. The one or more new colors, for example, may be stored directly in the memory on the CPU while the portion of first image 400 is being rendered.

According to certain aspects, the predetermined number may also be selected based on a downsampling factor for downsampling first image 400. The downsampling factor may be any suitable value depending on the degree of downsampling desired. For example, first image 400 may comprise a resolution of 1024 by 1024 pixels. The downsampling factor may be selected to downsample each side of first image 400 by a factor of four to generate a resolution of 256 by 256 pixels for the second image. In some aspects, the downsampling factor may be less than or equal to four. In some aspects, the predetermined number may be selected to be the same as the downsampling factor so that the CPU may conveniently render and downsample the portion of first image 400.

According to step S208, reduction module 106 may downsample the portion of first image 400 according to the downsampling factor to generate a portion of the second image. As discussed above, the second image comprises a downsampled version of first image 400. FIG. 5 illustrates an example of second image 500, in accordance with various aspects of the subject technology. As shown, second image 500 comprises three scanlines (e.g., shown as scanline 1 to scanline 3), with each of these scanlines comprising a plurality of pixels 502. However, second image 500 may be any suitable size, with greater or fewer scanlines and/or pixels depending on the degree of downsampling desired. For example, reduction module 106 may downsample the portion of first image 400 (e.g., scanline 1 through scanline 4 of first image 400) to generate the portion of second image 500 (e.g., scanline 1 of second image 500). After doing so, playback module 104 may render another portion of first image 400 (e.g., scanline 5 through scanline 8 of first image 400), and reduction module 106 may downsample this portion to generate another portion of second image 500 (e.g., scanline 2 of second image 500). This process may be repeated until first image 400 is rendered and downsampled to generate second image 500. For example, after scanline 2 of second image 500 has been generated, playback module 104 may render yet another portion of first image 400 (e.g., scanline 9 through scanline 12 of first image 400), and reduction module 106 may downsample this portion to generate yet another portion of second image 500 (e.g., scanline 3 of second image 500). Such a process allows the CPU to render and downsample first image 400 in a quick and efficient manner, as the memory on the CPU can be used directly for the rendering and downsampling.

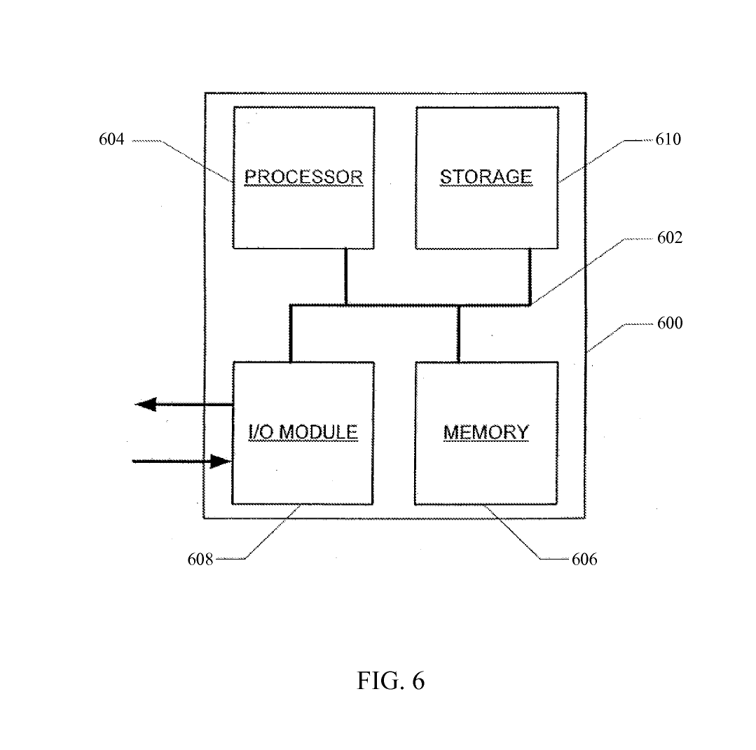

FIG. 6 is a block diagram illustrating components of controller 600, in accordance with various aspects of the subject technology. In some aspects, controller 600 may comprise the CPU. Controller 600 comprises processor module 604, storage module 610, input/output (I/O) module 608, memory module 606, and bus 602. In some aspects, memory module 606 may comprise the memory on the CPU. Bus 602 may be any suitable communication mechanism for communicating information. Processor module 604, storage module 610, I/O module 608, and memory module 606 are coupled with bus 602 for communicating information between any of the modules of controller 600 and/or information between any module of controller 600 and a device external to controller 600. For example, information communicated between any of the modules of controller 600 may include instructions and/or data. In some aspects, bus 602 may be a universal serial bus. In some aspects, bus 602 may provide Ethernet connectivity.

In some aspects, processor module 604 may comprise one or more processors, where each processor may perform different functions or execute different instructions and/or processes. For example, one or more processors may execute instructions for rendering and downsampling an image (e.g., method 200), and one or more processors may execute instructions for input/output functions.

Memory module 606 may be random access memory (“RAM”) or other dynamic storage devices for storing information and instructions to be executed by processor module 604. Memory module 606 may also be used for storing temporary variables or other intermediate information during execution of instructions by processor 604. In some aspects, memory module 606 may comprise battery-powered static RAM, which stores information without requiring power to maintain the stored information. Storage module 610 may be a magnetic disk or optical disk and may also store information and instructions. In some aspects, storage module 610 may comprise hard disk storage or electronic memory storage (e.g., flash memory). In some aspects, memory module 606 and storage module 610 are both a machine-readable medium.

Controller 600 is coupled via I/O module 608 to a user interface for providing information to and receiving information from an operator of system 100. For example, the user interface may be a cathode ray tube (“CRT”) or LCD monitor for displaying information to an operator. The user interface may also include, for example, a keyboard or a mouse coupled to controller 600 via I/O module 608 for communicating information and command selections to processor module 604.

According to various aspects of the subject disclosure, methods described herein are executed by controller 600. Specifically, processor module 604 executes one or more sequences of instructions contained in memory module 606 and/or storage module 610. In one example, instructions may be read into memory module 606 from another machine-readable medium, such as storage module 610. In another example, instructions may be read directly into memory module 606 from I/O module 608, for example from an operator of system 100 via the user interface. Execution of the sequences of instructions contained in memory module 606 and/or storage module 610 causes processor module 604 to perform methods to render and downsample an image. For example, a computational algorithm for rendering and downsampling an image may be stored in memory module 606 and/or storage module 610 as one or more sequences of instructions. Information such as the one or more drawing instructions, the first image, the second image, the line operations, the scanlines of the first image, the scanlines for the second image, the downsampling factor, the size of each of the line operations, the size of each of the scanlines of the first image, the size of the set of line operations, the size of the first image, and/or other suitable information may be communicated from processor module 604 to memory module 606 and/or storage module 610 via bus 602 for storage. In some aspects, the information may be communicated from processor module 604, memory module 606, and/or storage module 610 to I/O module 608 via bus 602. The information may then be communicated from I/O module 608 to an operator of system 100 via the user interface.

One or more processors in a multi-processing arrangement may also be employed to execute the sequences of instructions contained in memory module 606 and/or storage module 610. In some aspects, hard-wired circuitry may be used in place of or in combination with software instructions to implement various aspects of the subject disclosure. Thus, aspects of the subject disclosure are not limited to any specific combination of hardware circuitry and software.

The term “machine-readable medium,” or “computer-readable medium,” as used herein, refers to any medium that participates in providing instructions to processor module 604 for execution. Such a medium may take many forms, including, but not limited to, non-volatile media and volatile media. Non-volatile media include, for example, optical or magnetic disks, such as storage module 610. Volatile media include dynamic memory, such as memory module 606. Common forms of machine-readable media or computer-readable media include, for example, floppy disk, a flexible disk, hard disk, magnetic tape, any other magnetic medium, a CD-ROM, DVD, any other optical medium, punch cards, paper tape, any other physical mediums with patterns of holes, a RAM, a PROM, an EPROM, a FLASH EPROM, any other memory chip or cartridge, or any other medium from which a processor can read.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these configurations will be readily apparent to those skilled in the art, and generic principles defined herein may be applied to other configurations. Thus, many changes and modifications may be made to the subject technology, by one having ordinary skill in the art, without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples of the disclosure. A phrase such an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

Furthermore, to the extent that the term “include,” “have,” or the like is used in the description or the claims, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” The term “some” refers to one or more. All structural and functional equivalents to the elements of the various configurations described throughout this disclosure that are known or later come to be known to those of ordinary skill in the art are expressly incorporated herein by reference and intended to be encompassed by the subject technology.

What is claimed is:

1. A system for rendering and downsampling an image, the system comprising:
an instructions module configured to receive one or more drawing instructions associated with a first image, the instructions module further configured to generate line operations based on the one or more drawing instructions by encoding the first image, each of the line operations corresponding to a scanline of the first image, each of the line operations comprising a run-length encoded version of a corresponding scanline of the first image; and
a playback module configured to render a portion of the first image at a time based on a predetermined number of the line operations, the predetermined number being based on a downsampling factor for downsampling the first image.

2. The system of claim 1, wherein each of the line operations comprises one or more entries, each of the one or more entries comprising a rendering operation associated with at least a portion of a corresponding scanline.

3. The system of claim 2, wherein each rendering operation comprises at least one of a color descriptor or a location descriptor associated with the color descriptor.

4. The system of claim 2, wherein each of the one or more entries is less than or equal to 8 bytes.

5. The system of claim 1, wherein the instructions module is configured to store the line operations.

6. The system of claim 1, wherein the instructions module is configured to compare a size of each of the line operations to a size of a corresponding scanline of the first image, and wherein the instructions module is configured to determine whether to generate the line operations based on the comparison.

7. The system of claim 1, wherein the instructions module is configured to compare a size of the line operations to a size of the first image, and wherein the instructions module is configured to determine whether to generate the line operations based on the comparison.

8. The system of claim 1, wherein the playback module is configured to render the portion of the first image by rasterizing the portion of the first image.

9. The system of claim 1, further comprising a reduction module configured to downsample the portion of the first image to generate a portion of a second image, the second image comprising a downsampled version of the first image.

10. The system of claim 9, wherein the reduction module is configured to downsample the portion of the first image according to the downsampling factor.

11. The system of claim 9, wherein the first image comprises a supersampled image, the supersampled image comprising a resolution of at least 1024 by 1024 pixels, and wherein the downsampled image comprises a resolution of at most 256 by 256 pixels.

12. The system of claim 1, wherein the predetermined number comprises the downsampling factor and is less than or equal to four.

13. A computer-implemented method for rendering and downsampling an image, the method comprising:
receiving one or more drawing instructions associated with a first image;
generating line operations based on the one or more drawing instructions by encoding the first image, each of the line operations corresponding to a scanline of the first image, each of the line operations comprising a run-length encoded version of a corresponding scanline of the first image; and
rendering a portion of the first image at a time based on a predetermined number of the line operations, the predetermined number being based on a downsampling factor for downsampling the first image.

14. The method of claim 13, further comprising:
comparing a size of the line operations to a size of the first image; and
determining whether to generate the line operations based on the comparison.

15. The method of claim 13, wherein rendering the portion of the first image comprises rasterizing the portion of the first image.

16. The method of claim 13, further comprising downsampling the portion of the first image to generate a portion of a second image, the second image comprising a downsampled version of the first image.

17. A system for rendering and downsampling an image, the system comprising:
an image processor configured to:
receive one or more drawing instructions associated with a first image;
generate line operations based on the one or more drawing instructions by encoding the first image, each of the line operations corresponding to a scanline of the first image, each of the line operations comprising a run-length encoded version of a corresponding scanline of the first image; and
render a portion of the first image at a time based on a predetermined number of the line operations, the predetermined number being based on a downsampling factor for downsampling the first image.

18. The system of claim 17, wherein the image processor is configured to compare a size of each of the line operations to a size of a corresponding scanline of the first image, and wherein the image processor is configured to determine whether to generate the line operations based on the comparison.

19. A machine-readable medium encoded with executable instructions for rendering and downsampling an image, the instructions comprising code for:
receiving one or more drawing instructions associated with a first image;
generating line operations based on the one or more drawing instructions by encoding the first image, each of the line operations corresponding to a scanline of the first image, each of the line operations comprising a run-length encoded version of a corresponding scanline of the first image;
rendering a portion of the first image at a time based on a predetermined number of the line operations, the predetermined number being based on a downsampling factor for downsampling the first image; and
downsampling the portion of the first image according to the downsampling factor to generate a portion of a second image.

20. The machine-readable medium of claim 19, wherein the instructions further comprise code for:
comparing a size of the line operations to a size of the first image; and
determining whether to generate the line operations based on the comparison.
